(19) United States
(12) Patent Application Publication
(10) Pub. No.: US 2025/0273406 A1
(43) Pub. Date: Aug. 28, 2025

(54) ELECTRODE STRUCTURE AND METHOD OF MANUFACTURING THE SAME

(71) Applicant: NANYA TECHNOLOGY CORPORATION, New Taipei city (TW)

(72) Inventor: Wei-Chuan FANG, New Taipei City (TW)

(21) Appl. No.: 18/583,937

(22) Filed: Feb. 22, 2024

(51) Int. Cl. H01G 11/26; H01G 11/24; H01G 11/30; H01G 11/36

(52) U.S. Cl. CPC H01G 11/26; H01G 11/24; H01G 11/30; H01G 11/36

(57) ABSTRACT

The present disclosure provides an electrode structure. The electrode structure includes a substrate, a conductive layer, a nanoscale conductive structure, and a plurality of conductive particles. The conductive layer is disposed on the substrate. The nanoscale conductive structure is disposed on the conductive layer. The nanoscale conductive structure is doped with nitrogen dopant. The conductive particles are distributed on the nanoscale conductive structure.

### BACKGROUND

### Field of Invention

The present disclosure relates to an electrode structure and a method of manufacturing the same.

### Description of Related Art

Recently, supercapacitor development has been significantly focused due to electrical vehicle applications. As we know, traditional battery or capacitor cannot provide enough power deliver request. Hence, fast charging discharging performance with high current is needed in the contemporary environment.

Previous study shows that electrode materials (for example, vanadium oxide (V₂O₅)) synthesized by chemical method may be eligible. To increase surface area of the chemical reaction, graphene is used for the dispersion of the aforementioned electrode materials. However, such this approach cannot efficiently provide adequate power demand and satisfying stability.

Therefore, how to propose an electrode structure and a method of manufacturing the same that can improve the electrical performance of the electrode structure is one of the problems that the industry is eager to invest in research and development resources to solve.

### SUMMARY

In view of this, one purpose of present disclosure is to provide an electrode structure and a method of manufacturing the same that can solve the aforementioned problems.

In order to achieve the above objective, according to an embodiment of the present disclosure, the electrode structure includes a substrate, a conductive layer, a nanoscale conductive structure, and a plurality of conductive particles. The conductive layer is disposed on the substrate. The nanoscale conductive structure is disposed on the conductive layer. The nanoscale conductive structure is doped with nitrogen dopant. The conductive particles are distributed on the nanoscale conductive structure.

In one or more embodiments of the present disclosure, the substrate is substantially a silicon substrate.

In one or more embodiments of the present disclosure, the conductive layer is made of metal silicide.

In one or more embodiments of the present disclosure, the conductive layer is composed of titanium disilicide (TiSi₂).

In one or more embodiments of the present disclosure, the nanoscale conductive structure comprises a plurality of carbon nanotubes.

In one or more embodiments of the present disclosure, the carbon nanotubes are elongated in a direction from the substrate to the conductive layer.

In one or more embodiments of the present disclosure, the conductive particles are composed of vanadium nitride.

In one or more embodiments of the present disclosure, the conductive particles are substantially dispersed on the nanoscale conductive structure.

In order to achieve the above objective, according to an embodiment of the present disclosure, the electrode structure includes a substrate, a conductive layer, a nanoscale conductive structure, and a plurality of conductive particles. The conductive layer is disposed on the substrate. The nanoscale conductive structure is disposed on the conductive layer. The nanoscale conductive structure comprises a plurality of carbon nanotubes. The conductive particles are distributed on the nanoscale conductive structure.

In one or more embodiments of the present disclosure, the substrate is substantially a silicon substrate.

In one or more embodiments of the present disclosure, the conductive layer is made of metal silicide.

In one or more embodiments of the present disclosure, the conductive layer is composed of titanium disilicide (TiSi₂).

In one or more embodiments of the present disclosure, the carbon nanotubes are elongated in a direction from the substrate to the conductive layer.

In one or more embodiments of the present disclosure, the carbon nanotubes are ion-implanted.

In one or more embodiments of the present disclosure, the conductive particles are composed of vanadium nitride.

In one or more embodiments of the present disclosure, the conductive particles are substantially dispersed on the nanoscale conductive structure.

In order to achieve the above objective, according to an embodiment of the present disclosure, a method of manufacturing an electrode structure includes: providing a substrate; forming a conductive layer on the substrate; forming a nanoscale conductive structure on the conductive layer; doping the nanoscale conductive structure with nitrogen dopant; and forming a plurality of conductive particles on the nanoscale conductive structure.

In one or more embodiments of the present disclosure, the nanoscale conductive structure comprises a plurality of carbon nanotubes, and forming the nanoscale conductive structure is performed such that the carbon nanotubes are elongated in a direction from the substrate to the conductive layer.

In one or more embodiments of the present disclosure, forming the conductive particles on the nanoscale conductive structure is performed such that the conductive particles are evenly distributed on each of the carbon nanotubes.

In one or more embodiments of the present disclosure, doping the nanoscale conductive structure with nitrogen dopant is performed before forming the conductive particles on the nanoscale conductive structure.

In summary, the electrode structure and the method of manufacturing the same of the present disclosure provides an electrode structure with adequate power demand and satisfying stability. In the electrode structure and the method of manufacturing the same of the present disclosure, since the conductive particles are composed of vanadium nitride, the capacitance of the electrode structure can be well-improved. In the electrode structure and the method of manufacturing the same of the present disclosure, since the nanoscale conductive structure is doped with nitrogen, the nitrogen-doped nanoscale conductive structure can reduce the impedance of the electrode structure and further allow the conductive particles to be evenly distributed on the nanoscale conductive structure. In the electrode structure and the method of manufacturing the same of the present disclosure, since the nanoscale conductive structure includes carbon nanotubes, the nanoscale conductive structure can ultimately reach the nanoscale demand, thereby minimizing the electrode structure and improving the electrical efficiency. To sum up, the electrode structure and the method of manufacturing the same of the present disclosure achieves the effect of fast charging and discharging of the battery.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a flow chart of a method of manufacturing an electrode structure in accordance with an embodiment of present disclosure;

FIG. 2 is a schematic view of an intermediate stage of manufacturing an electrode structure in accordance with an embodiment of present disclosure;

FIG. 3 is a schematic view of an intermediate stage of manufacturing the electrode structure in accordance with another embodiment of present disclosure;

FIG. 4 is a schematic view of an intermediate stage of manufacturing the electrode structure in accordance with an embodiment of present disclosure;

FIG. 5 is a schematic view of an intermediate stage of manufacturing the electrode structure in accordance with an embodiment of present disclosure; and

FIG. 6 is a schematic view of an intermediate stage of manufacturing the electrode structure in accordance with an embodiment of present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, “around,” “about,” “approximately,” or “substantially” shall generally mean within 20 percent, or within 10 percent, or within 5 percent of a given value or range. Numerical quantities given herein are approximate, meaning that the term “around,” “about,” “approximately,” or “substantially” can be inferred if not expressly stated.

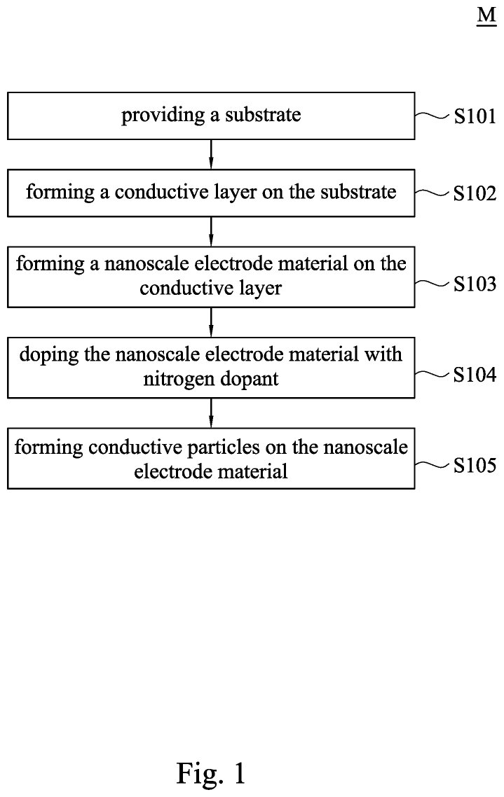

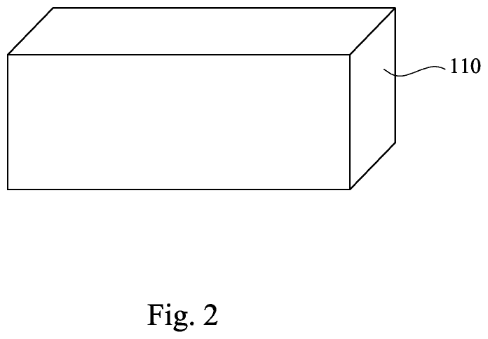

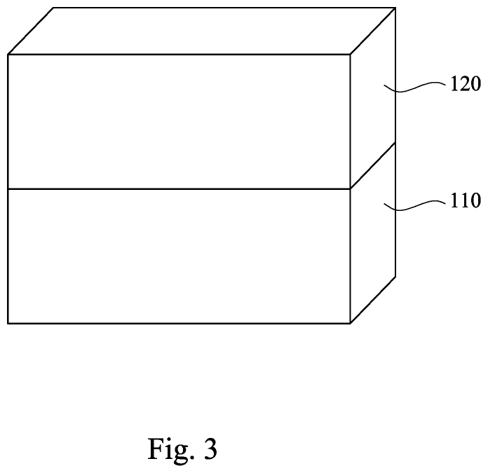

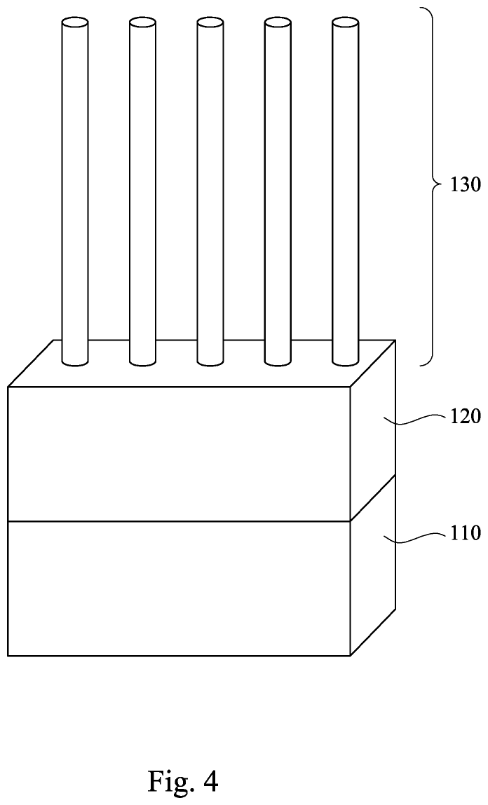

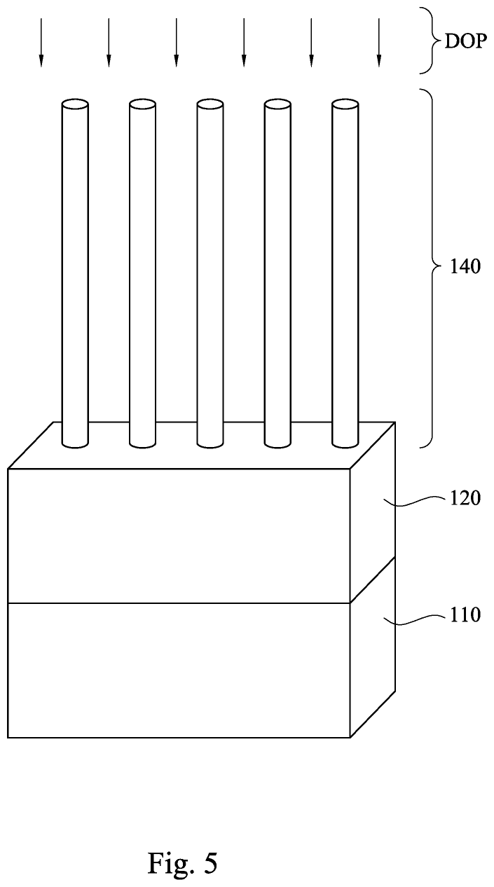

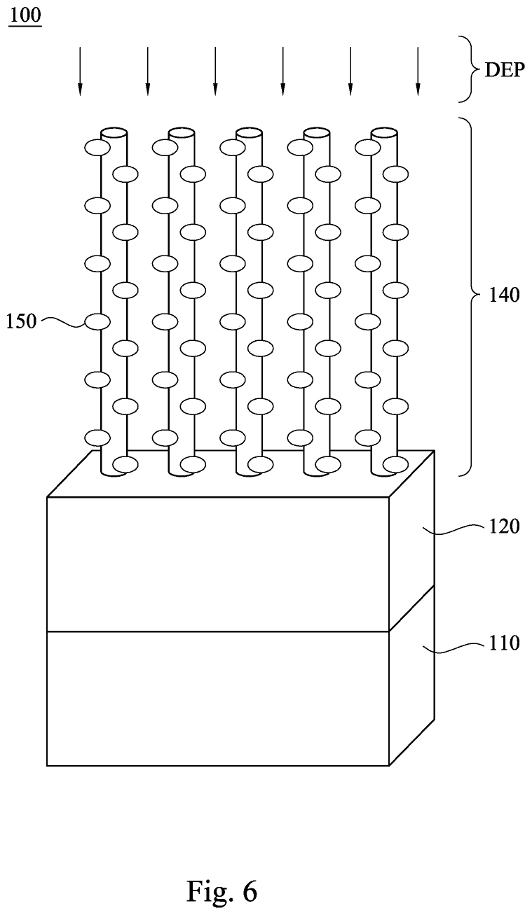

Reference is made to FIG. 1. FIG. 1 is a flow chart of a method M of manufacturing an electrode structure 100 as shown in FIG. 6 and an electrode structure 100 as shown in FIG. 6 in accordance with an embodiment of present disclosure. The method M shown in FIG. 1 includes a step S101, a step S102, a step S103, a step S104, and a step S105. Please refer to FIG. 1 and FIG. 2 for better understanding the step S101, refer to FIG. 1 and FIG. 3 for better understanding the step S102, refer to FIG. 1 and FIG. 4 for better understanding the step S103, refer to FIG. 1 and FIG. 5 for better understanding the step S104, and refer to FIG. 1 and FIG. 6 for better understanding the step S105.

Step S101, step S102, step S103, step S104, and step S105 are described in detail below.

In step S101, a substrate 110 is provided, as shown in FIG. 2.

Reference is made to FIG. 2. FIG. 2 is a schematic view of an intermediate stage of manufacturing the electrode structure 100 in accordance with an embodiment of the present disclosure. As shown in FIG. 2, a substrate 110 is provided. In this embodiment, the substrate 110 is substantially a silicon substrate. In some embodiments, the substrate 110 is substantially a wafer.

In some embodiments, the substrate 110 is configured as the electrode the semiconductor device. In some embodiments, the substrate 110 may include a material, such as polysilicon, monocrystalline silicon, amorphous silicon, or the like. However, any suitable material may be utilized.

In some embodiments, the substrate 110 may be formed by any suitable method, for example, CVD (chemical vapor deposition), PECVD (plasma-enhanced chemical vapor deposition), PVD (physical vapor deposition), ALD (atomic layer deposition), PEALD (plasma-enhanced atomic layer deposition), ECP (electrochemical plating), electroless plating, or the like. The present disclosure is not intended to limit the methods of forming the substrate 110.

In step S102, a conductive layer 120 is formed on the substrate 110, as shown in FIG. 3.

Reference is made to FIG. 3. FIG. 3 is a schematic view of an intermediate stage of manufacturing the electrode structure 100 in accordance with an embodiment of the present disclosure. In this embodiment, a conductive layer 120 is disposed on the substrate 110.

In some embodiments, the conductive layer 120 may be made of conductive material. In some embodiments, the conductive layer 120 may be composed of metal silicide. In some embodiments, the conductive layer 120 may include a material, such as titanium disilicide (TiSi₂), cobalt disilicide (CoSi₂), or the like. However, any suitable material may be utilized.

In some embodiments, the conductive layer 120 may be formed by any suitable method, for example, CVD (chemical vapor deposition), PECVD (plasma-enhanced chemical vapor deposition), PVD (physical vapor deposition), ALD (atomic layer deposition), PEALD (plasma-enhanced atomic layer deposition), ECP (electrochemical plating), electroless plating, or the like. The present disclosure is not intended to limit the methods of forming the conductive layer 120.

In step S103, a nanoscale conductive structure 130 is formed on the conductive layer 120, as shown in FIG. 4.

Reference is made to FIG. 4. FIG. 4 a schematic view of an intermediate stage of manufacturing the electrode structure 100 in accordance with an embodiment of the present disclosure. In this embodiment, a nanoscale conductive structure 130 is disposed on the conductive layer 120. As shown in FIG. 4, in some embodiments, the nanoscale conductive structure 130 consists of a plurality of bar-shaped conductive material. In some embodiments, the nanoscale conductive structure 130 may include a plurality of carbon nanotubes (CNTs). However, any suitable material may be utilized. As shown in FIG. 4, in some embodiments in which the nanoscale conductive structure includes the carbon nanotubes, the carbon nanotubes are elongated in a direction from the substrate 110 to the conductive layer 120. In some embodiments, the carbon nanotubes are freestanding (that is, the carbon nanotubes are separated to each other).

In some embodiments, the nanoscale conductive structure 130 may be formed by any suitable method, for example, arc discharge, laser ablation, CVD (chemical vapor deposition), PECVD (plasma-enhanced chemical vapor deposition), PVD (physical vapor deposition), ALD (atomic layer deposition), PEALD (plasma-enhanced atomic layer deposition), or the like. The present disclosure is not intended to limit the methods of forming the nanoscale conductive structure 130.

In step S104, the nanoscale conductive structure 130 is doped, as shown in FIG. 5.

Reference is made to FIG. 5. FIG. 5 a schematic view of an intermediate stage of manufacturing the electrode structure 100 in accordance with an embodiment of the present disclosure. In this embodiment, the nanoscale conductive structure 130 is modified by performing a modifying process DOP. More specifically, the nanoscale conductive structure 130 is reacted by the modifying process DOP, such that the nanoscale conductive structure 130 is transformed into a modified nanoscale conductive structure 140. In some embodiments, the modified nanoscale conductive structure 140 is formed from the nanoscale conductive structure 130 on the conductive layer 120 in situ.

In some embodiments, the modifying process DOP includes a doping process. In some embodiments, the modifying process DOP may include a method, such as an ion implantation, or the like. However, the present disclosure is not intended to limit the type of modifying process DOP.

In some embodiments, the modified nanoscale conductive structure 140 may include a plurality of doped carbon nanotubes (CNTs). However, any suitable material may be utilized.

In some embodiments, the modified nanoscale conductive structure 140 may be doped with a dopant, such as nitrogen (N), or the like. However, the present disclosure is not intended to limit the type of the dopant doping the modified nanoscale conductive structure 140.

In some embodiments, the modified nanoscale conductive structure 140 may be formed by any suitable method, for example, arc discharge, laser ablation, CVD (chemical vapor deposition), PECVD (plasma-enhanced chemical vapor deposition), PVD (physical vapor deposition), ALD (atomic layer deposition), PEALD (plasma-enhanced atomic layer deposition), or the like. The present disclosure is not intended to limit the methods of forming the modified nanoscale conductive structure 140.

In step S105, a plurality of conductive particles 150 are formed on the modified nanoscale conductive structure 140, as shown in FIG. 6.

Reference is made to FIG. 6. FIG. 6 a schematic view of an intermediate stage of manufacturing the electrode structure 100 in accordance with an embodiment of the present disclosure. In this embodiment, conductive particles 150 are formed on the modified nanoscale conductive structure 140 by performing a deposition process DEP. More specifically, the deposition process DEP is performed, such that the conductive particles 150 are distributed on the modified nanoscale conductive structure 140. After the step S105 is performed, the electrode structure 100 is formed.

In some embodiments, the conductive particles 150 are substantially evenly distributed on the modified nanoscale conductive structure 140. In some embodiments, the conductive particles 150 are substantially dispersed on the modified nanoscale conductive structure 140. In some embodiments in which the modified nanoscale conductive structure 140 includes carbon nanotubes, the conductive particles 150 are evenly distributed on each of the carbon nanotubes.

In some embodiments, the conductive particles 150 may be composed of conductive material. In some embodiments, the conductive particles 150 may be composed of metallic material. In some embodiments, the conductive particles 150 may include a material, such as vanadium nitride (VN), or the like. However, any suitable material may be utilized.

In some embodiments, the conductive particles 150 may be formed by any suitable method, for example, CVD (chemical vapor deposition), PECVD (plasma-enhanced chemical vapor deposition), PVD (physical vapor deposition), ALD (atomic layer deposition), PEALD (plasma-enhanced atomic layer deposition), ECP (electrochemical plating), electroless plating, or the like. The present disclosure is not intended to limit the methods of forming the conductive particles 150.

In some embodiments in which the conductive particles 150 are formed by PVD (physical vapor deposition), vanadium (V) is used as a sputter target, and ammonia (NH₃), nitrogen gas (N₂), or the combination thereof is used as process gas.

In some embodiments, doping the nanoscale conductive structure with nitrogen dopant in step S104 is preferably performed before forming the conductive particles on the nanoscale conductive structure in step S105.

By performing the method M shown in FIG. 1 of the present disclosure, the electrode structure 100 with better electrical performance may be formed. More specifically, the conductive particles 150 made of vanadium nitride (VN) have an advantage of high capacitance but with a disadvantage of insufficient conductivity. However, the modified nanoscale conductive structure 140 formed by doping the nanoscale conductive structure 130 with nitrogen dopant has an advantage of decreased electrical resistivity. The combination of the modified nanoscale conductive structure 140 and the conductive particles 150 does improve both the capacitance and the conductivity of the electrode structure 100 that can satisfy the consumers' needs.

Based on the above discussions, it can be seen that the electrode structure and the method of manufacturing the same of the present disclosure provides an electrode structure with adequate power demand and satisfying stability. In the electrode structure and the method of manufacturing the same of the present disclosure, since the conductive particles are composed of vanadium nitride, the capacitance of the electrode structure can be well-improved. In the electrode structure and the method of manufacturing the same of the present disclosure, since the nanoscale conductive structure is doped with nitrogen, the nitrogen-doped nanoscale conductive structure can reduce the impedance of the electrode structure and further allow the conductive particles to be evenly distributed on the nanoscale conductive structure. In the electrode structure and the method of manufacturing the same of the present disclosure, since the nanoscale conductive structure includes carbon nanotubes, the nanoscale conductive structure can ultimately reach the nanoscale demand, thereby minimizing the electrode structure and improving the electrical efficiency. To sum up, the electrode structure and the method of manufacturing the same of the present disclosure achieves the effect of fast charging and discharging of the battery.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electrode structure, comprising:
a substrate;
a conductive layer disposed on the substrate;
a nanoscale conductive structure disposed on the conductive layer, wherein the nanoscale conductive structure is doped with nitrogen dopant; and
a plurality of conductive particles distributed on the nanoscale conductive structure.

2. The electrode structure of claim 1, wherein the substrate is substantially a silicon substrate.

3. The electrode structure of claim 1, wherein the conductive layer is made of metal silicide.

4. The electrode structure of claim 3, wherein the conductive layer is composed of titanium disilicide (TiSi₂).

5. The electrode structure of claim 1, wherein the nanoscale conductive structure comprises a plurality of carbon nanotubes.

6. The electrode structure of claim 5, wherein the carbon nanotubes are elongated in a direction from the substrate to the conductive layer.

7. The electrode structure of claim 1, wherein the conductive particles are composed of vanadium nitride.

8. The electrode structure of claim 1, wherein the conductive particles are substantially dispersed on the nanoscale conductive structure.

9. An electrode structure, comprising:
a substrate;
a conductive layer disposed on the substrate;
a nanoscale conductive structure disposed on the conductive layer, wherein the nanoscale conductive structure comprises a plurality of carbon nanotubes; and
a plurality of conductive particles distributed on the nanoscale conductive structure.

10. The electrode structure of claim 9, wherein the substrate is substantially a silicon substrate.

11. The electrode structure of claim 9, wherein the conductive layer is made of metal silicide.

12. The electrode structure of claim 11, wherein the conductive layer is composed of titanium disilicide (TiSi₂).

13. The electrode structure of claim 9, wherein the carbon nanotubes are elongated in a direction from the substrate to the conductive layer.

14. The electrode structure of claim 9, wherein the carbon nanotubes are ion-implanted.

15. The electrode structure of claim 9, wherein the conductive particles are composed of vanadium nitride.

16. The electrode structure of claim 9, wherein the conductive particles are substantially dispersed on the nanoscale conductive structure.

17. A method of manufacturing an electrode structure, comprising:
providing a substrate;
forming a conductive layer on the substrate;
forming a nanoscale conductive structure on the conductive layer;
doping the nanoscale conductive structure with nitrogen dopant; and
forming a plurality of conductive particles on the nanoscale conductive structure.

18. The method of claim 17, wherein the nanoscale conductive structure comprises a plurality of carbon nanotubes, and forming the nanoscale conductive structure is performed such that the carbon nanotubes are elongated in a direction from the substrate to the conductive layer.

19. The method of claim 18, wherein forming the conductive particles on the nanoscale conductive structure is performed such that the conductive particles are evenly distributed on each of the carbon nanotubes.

20. The method of claim 17, wherein doping the nanoscale conductive structure with nitrogen dopant is performed before forming the conductive particles on the nanoscale conductive structure.
